(19) United States
(12) Patent Application Publication
(10) Pub. No.: US 2020/0274159 A1
(43) Pub. Date: Aug. 27, 2020

(54) PROCESS FOR MAKING AN ELECTRODE ACTIVE MATERIAL

(71) Applicant: BASF SE, Ludwigshafen am Rhein (DE)

(72) Inventors: Jordan K LAMPERT, Beachwood, OH (US); Brandon Ray LONG, Beachwood, OH (US); Jacob HAAG, Beachwood, OH (US); Xiao Hang LIU, Shanghai (CN); Johan TER MAAT, Ludwigshafen (DE)

(73) Assignee: BASF SE, Ludwigshafen am Rhein (DE)

(21) Appl. No.: 16/646,641

(22) PCT Filed: Sep. 10, 2018
(86) PCT No.: PCT/EP2018/074337

§ 371 Date: Mar. 12, 2020

(30) Foreign Application Priority Data
Sep. 20, 2017 (EP) 17192024.2

(51) Int. Cl. H01M 4/525; C01G 53/00; H01M 4/505

(52) U.S. Cl. CPC H01M 4/525; C01G 53/50; C01P 2002/50; C01P 2006/40; H01M 4/505

(57) ABSTRACT

Process for making an electrode active material according to general formula Li₁₊ₓTM₁₋ₓO₂, wherein TM is a combination of Mn, Co and Ni, optionally in combination with at least one more metal selected from Al, Ti, and W, wherein at least 50 mole-% of TM is Ni, and x is in the range of from zero to 0.2, said process comprising the following steps: (a) mixing (A) a mixed oxide or oxyhydroxide or hydroxide of TM, and (B) at least one lithium compound selected from lithium hydroxide, lithium oxide and lithium carbonate, and so that the molar ratio of Li to TM is in the range of from 0.70 to 0.97. (b) Subjecting said mixture to heat treatment at a temperature in the range of from 300 to 900° C., (c) Mixing with at least one lithium compound (B), so that the total molar ratio of Li to TM is in the range of from 1.0 to 1.1, (d) Subjecting said mixture to heat treatment at a temperature in the range of from 700 to 1000° C.

The present invention is directed towards a process for making an electrode active material according to general formula Li₁₊ₓTM₁₋ₓO₂, wherein TM is a combination of Mn, Co and Ni, optionally in combination with at least one more metal selected from Al, Ti, and W, wherein at least 50 mole-% of TM is Ni, and x is in the range of from zero to 0.2, said process comprising the following steps:

(a) mixing
(A) a mixed oxide or oxyhydroxide or hydroxide of TM, and
(B) at least one lithium compound selected from lithium hydroxide, lithium oxide and lithium carbonate, and
   so that the molar ratio of Li to TM is in the range of from 0.70 to 0.97,
(b) Subjecting said mixture to heat treatment at a temperature in the range of from 300 to 900° C.,
(c) Mixing with at least one lithium compound (B), so that the total molar ratio of Li to TM is in the range of from 1.0 to 1.1,
(d) Subjecting said mixture to heat treatment at a temperature in the range of from 700 to 1000° C.

Lithiated transition metal oxides are currently being used as electrode active materials for lithium-ion batteries. Extensive research and developmental work has been performed in the past years to improve properties like charge density, specific energy, but also other properties like the reduced cycle life and capacity loss that may adversely affect the lifetime or applicability of a lithium-ion battery. Additional effort has been spent to improve manufacturing methods.

In a typical process for making electrode active materials for lithium-ion batteries, first a so-called precursor is being formed by co-precipitating the transition metals as carbonates, oxides or preferably as hydroxides that may or may not be basic. The precursor is then mixed with a lithium salt such as, but not limited to LiOH, Li₂O or—especially—Li₂CO₃— and calcined (fired) at high temperatures. Lithium salt(s) can be employed as hydrate(s) or in dehydrated form. The calcination—or firing—generally also referred to as thermal treatment or heat treatment of the precursor—is usually carried out at temperatures in the range of from 600 to 1,000° C. During the thermal treatment a solid state reaction takes place, and the electrode active material is formed. In cases hydroxides or carbonates are used as precursors the solid state reaction follows a removal of water or carbon dioxide. The thermal treatment is performed in the heating zone of an oven or kiln.

Many electrode active materials discussed today are of the type of lithiated nickel-cobalt-manganese oxide (“NCM materials”). Many NCM materials used in lithium ion batteries have an excess of lithium compared to the transition metal, see, e.g., U.S. Pat. No. 6,677,082. However, in large scale production, it can be observed that non-incorporated lithium is left in the electrode active material. The residual lithium carbonate is undesired because it reduces the cyclability and the capacity of lithium ion batteries.

Especially when calcinations are performed in pusher kilns and roller hearth kilns, in which precursor and lithium source are calcined in saggars that are moved through the kiln, the kiln capacity is reduced because at higher saggar loadings the demand of a low lithium carbonate content cannot be met easily.

It was therefore an objective of the present invention to provide a method for making an electrode active material that can be calcined with high saggar loadings without suffering from a high residual lithium carbonate content.

Accordingly, the process as defined at the outset has been found, hereinafter also defined as inventive process or as process according to the current invention. The inventive process shall be described in more detail below.

The inventive process is a process for making an electrode active material according to general formula Li₁₊ₓTM₁₋ₓO₂, Li₁₊ₓTM₁₋ₓO₂, wherein TM is a combination of Mn, Co and Ni, optionally in combination with at least one more metal selected from Al, Ti, and W, wherein at least 50 mole-% of TM is Ni, and x is in the range of from zero to 0.2, preferably 0.01 to 0.05, said process comprising the following steps, hereinafter in brief also referred to as step (a) and step (b), respectively.

Step (a) includes mixing
(A) a mixed oxide or oxyhydroxide of Mn, Co and Ni, hereinafter also referred to as oxyhydroxide (A) or oxide (A) or precursor (A), and
(B) at least one lithium compound selected from lithium hydroxide, lithium oxide and lithium carbonate, hereinafter also referred to as lithium salt (B) or lithium compound (B),
   so that the molar ratio of Li to TM is in the range of from 0.70 to 0.97, preferably 0.90 to 0.95.

In one embodiment of the present invention, precursor (A) is obtained by co-precipitation of a mixed hydroxide of nickel, cobalt and manganese, followed by drying under air and partial or full dehydration.

Precursor (A) may be obtained by co-precipitating nickel, cobalt and manganese as hydroxides followed by drying in an atmosphere containing oxygen and a thermal pre-treatment in an atmosphere containing oxygen.

Precursor (A) is preferably obtained by co-precipitating nickel, cobalt and manganese as hydroxides from an aqueous solution containing nitrates, acetates or preferably sulfates of nickel, cobalt and manganese in a stoichiometric ratio corresponding to TM. Said co-precipitation is effected by the addition of alkali metal hydroxide, for example potassium hydroxide or sodium hydroxide, in a continuous, semi-continuous or batch process. Said co-precipitation is then followed by removal of the mother liquor, for example filtration, and subsequent removal of water.

It is even more preferred that TM in the targeted electrode active material is the same as TM in precursor (A) plus the metal M, see below.

The removal of water is preferably performed in at least two sub-steps at different temperatures, for example 80 to 150° C. in sub-step 1 and 165 to 600° C. in sub-step 2.

In one embodiment of the present invention, the removal of water is performed in different apparatuses. Sub-step 1 is preferably performed in a spray dryer, in a spin-flash dryer or in a contact dryer. Sub-step 2 may be performed in a rotary kiln, a roller heath kiln or in a box kiln.

Precursor (A) is in particulate form. In one embodiment of the present invention, the mean particle diameter (D50) of precursor (A) is in the range of from 6 to 12 μm, preferably 7 to 10 μm. The mean particle diameter (D50) in the context of the present invention refers to the median of the volume-based particle diameter, as can be determined, for example, by light scattering.

The particle shape of the secondary particles of precursor (A) is preferably spheroidal, that are particles that have a spherical shape. Spherical spheroidal shall include not just those which are exactly spherical but also those particles in which the maximum and minimum diameter of at least 90% (number average) of a representative sample differ by not more than 10%.

In one embodiment of the present invention, precursor (A) is comprised of secondary particles that are agglomerates of primary particles. Preferably, precursor (A) is comprised of spherical secondary particles that are agglomerates of primary particles. Even more preferably, precursor (A) is comprised of spherical secondary particles that are agglomerates of spherical primary particles or platelets.

In one embodiment of the present invention, precursor (A) may have a particle diameter distribution span in the range of from 0.5 to 0.9, the span being defined as [(D90)−(D10)] divided by (D50), all being determined by LASER analysis. In another embodiment of the present invention, precursor (A) may have a particle diameter distribution span in the range of from 1.1 to 1.8.

In one embodiment of the present invention the surface (BET) of precursor (A) is in the range of from 2 to 10 m²/g, determined by nitrogen adsorption, for example in accordance with to DIN-ISO 9277:2003-05.

In one embodiment of the present invention precursor (A) may have a homogeneous distribution of the transition metals nickel, cobalt and manganese over the diameter of the particles. In other embodiments of the present invention, the distribution of at least two of nickel, cobalt and manganese is non-homogeneous, for example exhibiting a gradient of nickel and manganese, or showing layers of different concentrations of at least two of nickel, cobalt and manganese. It is preferred that precursor (A) has a homogeneous distribution of the transition metals over the diameter of particles.

In one embodiment of the present invention, precursor (A) may contain elements other than nickel, cobalt and manganese, for example titanium, aluminum, zirconium, vanadium, tungsten, molybdenum, niobium or magnesium, for example in amounts of 0.1 to 5% by mole, referring to TM. Preferred are aluminum, tungsten and titanium, and more preferred is aluminum.

Precursor (A) may contain traces of metal ions, for example traces of ubiquitous metals such as sodium, calcium, iron or zinc, as impurities but such traces will not be taken into account in the description of the present invention. Traces in this context will mean amounts of 0.05 mol-% or less, referring to the total metal content of TM.

In one embodiment of the present invention, precursor (A) contains one or more impurities such as residual sulphate in case such precursor has been made by co-precipitation from a solution of one or more sulphates of nickel, cobalt and manganese. The sulphate may be in the range of from 0.1 to 0.4% by weight, referring to the entire precursor (A).

In one embodiment of the present invention, TM is of the general formula (I)

(NiₐCo_{b}Mn_{c})_{1-d}M_{d} (I)

with
a being in the range of from 0.5 to 0.9, preferably 0.6 to 0.9 and more preferably 0.6 to 0.7,
b being in the range of from 0.025 to 0.2, preferably 0.05 to 0.2 and more preferably 0.1 to 0.2,
c being in the range of from 0.025 to 0.3, preferably 0.05 to 0.2 and more preferably 0.1 to 0.2, and
d being in the range of from 0.005 to 0.1,
and M is Al, Ti or Zr or a combination of at least two out of Al, Ti and Zr, preferably M is Al, and

a+b+c=1.

In a preferred embodiment of the present invention, at least 60 mole-% of TM is Ni, for example 60 to 95 mole-%, more preferably 60 to 90 mole % and even more preferably 60 to 80 mole-%, the percentage in each case referring to the sum of Ni, Co and Mn. Specific examples are Ni_{0.5}Co_{0.2}Mn_{0.3}, Ni_{0.6}Co_{0.2}Mn_{0.2}, Ni_{0.8}Co_{0.1}Mn_{0.1}, and Ni_{0.7}Co_{0.2}Mn_{0.1}.

In one embodiment of the present invention, precursor (A) is an oxide or oxyhydroxide of TM, and the resultant electrode active material is Li₁₊ₓTM₁₋ₓO₂, wherein TM in precursor (A) is the same with respect to the amounts of transition metals as in the electrode active material.

As precursor (A), oxyhydroxides with a residual moisture content in the range of from 0.1 to 50% by weight are particularly feasible. In the context of precursor (A), the moisture content is calculated as g H₂O per 100 g of precursor (A). In this case, H₂O may be bound chemically as hydroxyl group, or be bound by physisorption. It is preferred that the residual moisture in precursor (A) is low, for example 0.1 to 5% by weight. Even more preferably, precursor (A) is an oxide of TM with no detectable amounts of residual moisture.

Examples of lithium compound (B) are Li₂O, LiOH, and Li₂CO₃, each water-free or as hydrate, if applicable, for example LiOH.H₂O. Preferred example is lithium hydroxide.

Lithium compound (B) is preferable in particulate form, for example with an average diameter (D50) in the range of from 3 to 10 μm, preferably from 5 to 9 μm.

Examples of suitable apparatuses for performing step (a) are high-shear mixers, tumbler mixers, vibratory mixers, plough-share mixers and free fall mixers.

In one embodiment of the present invention, step (a) is performed at a temperature in the range of from ambient temperature to 200° C., preferably 20 to 50° C.

In one embodiment of the present invention, step (a) has a duration of 10 minutes to 2 hours. Depending on whether additional mixing is performed in step (b) or not, thorough mixing has to be accomplished in step (a).

Although it is possible to add an organic solvent, for example glycerol or glycol, or water in step (a) it is preferred to perform step (a) in the dry state, that is without addition of water or of an organic solvent.

A mixture is obtained.

In one embodiment of the present invention, a compound (C) is added during step (a). Compound (C) may serve as source of dopant. Compound (C) is selected from oxides, hydroxides and oxyhydroxides of Ti, W and especially of Al. Lithium titanate is also a possible source of titanium. Examples of compounds (C) are TiO₂ selected from rutile and anatase, anatase being preferred, furthermore basic titania such as TiO(OH)₂, furthermore L₄Ti₅O₁₂, WO₃, Al(OH)₃, Al₂O₃, Al₂O₃.aq, and AlOOH. Preferred are Al compounds such as Al(OH)₃, α-Al₂O₃, γ-Al₂O₃, Al₂O₃.aq, and AlOOH. Even more preferred compounds (C) are Al₂O₃ selected from α-Al₂O₃, γ-Al₂O₃, and most preferred is γ-Al₂O₃. In a preferred embodiment, compound (C) is applied in an amount of up to 1.5 mole % (referred to the sum of Ni, Co and Mn), preferably 0.1 up to 0.5 mole %.

Mixing of precursor (A), lithium compound (B) and compound (C) may be performed all in one or in sub-steps, for example by first mixing lithium compound (B) and compound (C) and adding such mixture to precursor (A), or by first mixing precursor (A) and lithium compound (B) and then adding compound (C), or by first mixing compound (C) and precursor (A) and then adding lithium compound (B). It is preferred to first mix precursor (A) and lithium compound (B) and to then add compound (C).

Step (b) includes subjecting said mixture to heat treatment at a temperature in the range of from 300 to 900° C., preferably 750 to 875° C.

In one embodiment of the present invention, the mixture of precursor (A) and lithium compound (B) and, optionally, solvent(s), is heated to 300 to 900° C. with a heating rate of 0.1 to 10° C./min.

In one embodiment of the present invention, the temperature is ramped up before reaching the desired temperature of from 300 to 900° C., preferably 750 to 875° C. For example, first the mixture of precursor (A) and lithium compound (B) and compound (C) is heated to a temperature to 300 to 550° C. and then held constant for a time of 10 min to 4 hours, and then it is raised to 700° C. up to 900° C.

In embodiments wherein in step (a) at least one solvent has been used, as part of step (b), or separately and before commencing step (b), such solvent(s) are removed, for example by filtration, evaporation or distilling of such solvent(s). Preferred are evaporation and distillation.

In one embodiment of the present invention, step (b) is performed in a roller hearth kiln, a pusher kiln or a rotary kiln or a combination of at least two of the foregoing. Rotary kilns have the advantage of a very good homogenization of the material made therein. In roller hearth kilns and in pusher kilns, different reaction conditions with respect to different steps may be set quite easily. In lab scale trials, box-type and tubular furnaces and split tube furnaces are feasible as well. Preferred are rotary kilns and rotary hearth kilns, with rotary hearth kilns being more preferred.

In one embodiment of the present invention, step (b) is performed in an oxygen-containing atmosphere, for example in a nitrogen-air mixture, in a rare gas-oxygen mixture, in air, in oxygen or in oxygen-enriched air. In a preferred embodiment, the atmosphere in step (b) is selected from air, oxygen and oxygen-enriched air. Oxygen-enriched air may be, for example, a 50:50 by volume mix of air and oxygen. Other options are 1:2 by volume mixtures of air and oxygen, 1:3 by volume mixtures of air and oxygen, 2:1 by volume mixtures of air and oxygen, and 3:1 by volume mixtures of air and oxygen.

In one embodiment of the present invention, step (b) of the present invention is performed under a stream of gas, for example air, oxygen and oxygen-enriched air. Such stream of gas may be termed a forced gas flow. Such stream of gas may have a specific flow rate in the range of from 0.5 to 15 m³/h·kg precursor (A). The volume is determined under normal conditions: 298 Kelvin and 1 atmosphere. Said stream of gas is useful for removal of gaseous cleavage products such as water and carbon dioxide.

An underlithiated electrode active material is obtained from step (b).

In one embodiment of the present invention, step (b) has a duration in the range of from one hour to 30 hours. Preferred are 10 to 24 hours. The cooling time is neglected in this context.

After thermal treatment in accordance to step (b), the electrode active material so obtained is preferably cooled down before further processing.

In step (c), the underlithiated electrode active material is mixed with at least one lithium compound (B), so that the total molar ratio of Li to TM is in the range of from 1.0 to 1.1, preferably 1.01 to 1.05.

In one embodiment of the present invention, lithium compound (B) in step (a) is the same as in step (c), for example, in both steps both Li₂CO₃ or in both steps LiOH is selected. Preferably, lithium compound (B) in step (a) is different from lithium compound (B) in step (c), for example, in step (a) Li₂CO₃ is selected as lithium compound (B) and in step (c) LiOH.

Examples of suitable apparatuses for performing step (c) are high-shear mixers, tumbler mixers, vibratory mixers, plough-share mixers and free fall mixers.

In one embodiment of the present invention, step (c) is performed at a temperature in the range of from ambient temperature to 200° C., preferably 20 to 50° C.

In one embodiment of the present invention, step (c) has a duration of 10 minutes to 2 hours. Depending on whether additional mixing is performed in step (c) or not, thorough mixing has to be accomplished in step (c).

Although it is possible to add an organic solvent, for example glycerol or glycol, or water in step (c) it is preferred to perform step (c) in the dry state, that is without addition of water or of an organic solvent.

A mixture is obtained.

In one embodiment of the present invention, a compound (C) is added during step (c) or immediately after step (c), wherein compound (C) is a compound of Al, Ti or Zr. Compound (C) may serve as source of dopant. Compound (C) is selected from oxides, hydroxides and oxyhydroxides of Ti, W and especially of Al. Lithium titanate is also a possible source of titanium. Examples of compounds (C) are TiO₂ selected from rutile and anatase, anatase being preferred, furthermore basic titania such as TiO(OH)₂, furthermore L₄Ti₅O₁₂, WO₃, Al(OH)₃, Al₂O₃, Al₂O₃.aq, and AlOOH. Preferred are Al compounds such as Al(OH)₃, α-Al₂O₃, γ-Al₂O₃, Al₂O₃.aq, and AlOOH. Even more preferred compounds (C) are Al₂O₃ selected from α-Al₂O₃, γ-Al₂O₃, and most preferred is γ-Al₂O₃. In a preferred embodiment, compound (C) is applied in an amount of up to 1.5 mole % (referred to the sum of Ni, Co and Mn), preferably 0.1 up to 0.5 mole %. Immediately after in this context means that compound (C) is added before step (d) is commenced.

Step (d) includes subjecting said mixture to heat treatment at a temperature in the range of from 700 to 1000° C., preferably 750 to 925° C., even more preferred 850 to 890° C.

In embodiments wherein in step (c) at least one solvent has been used, as part of step (d), or separately and before commencing step (d), such solvent(s) are removed, for example by filtration, evaporation or distilling of such solvent(s). Preferred are evaporation and distillation.

In one embodiment of the present invention, step (d) is performed in a roller hearth kiln, a pusher kiln or a rotary kiln or a combination of at least two of the foregoing. Rotary kilns have the advantage of a very good homogenization of the material made therein. In roller hearth kilns and in pusher kilns, different reaction conditions with respect to different steps may be set quite easily. In lab scale trials, box-type and tubular furnaces and split tube furnaces are feasible as well. Preferred are roller hearth kilns.

In one embodiment of the present invention, step (d) is performed in an oxygen-containing atmosphere, for example in a nitrogen-air mixture, in a rare gas-oxygen mixture, in air, in oxygen or in oxygen-enriched air. In a preferred embodiment, the atmosphere in step (d) is selected from air, oxygen and oxygen-enriched air. Oxygen-enriched air may be, for example, a 50:50 by volume mix of air and oxygen. Other options are 1:2 by volume mixtures of air and oxygen, 1:3 by volume mixtures of air and oxygen, 2:1 by volume mixtures of air and oxygen, and 3:1 by volume mixtures of air and oxygen.

In one embodiment of the present invention, step (d) has a duration in the range of from one hour to 30 hours. Preferred are 10 to 24 hours. The cooling time is neglected in this context.

After thermal treatment in accordance to step (d), the electrode active material so obtained is cooled down before further processing.

By performing the inventive process electrode active materials with excellent properties are available through a straightforward process. Preferably, the electrode active materials so obtained have a residual lithium carbonate content in the range of from 0.03 to 0.2% by weight, determined by titration with aqueous HCl, and a total residual lithium hydroxide content of less than 0.30% by weight, determined by aqueous HCl, even if performed in big saggars of 4 or 5 kg loading or more in a roller hearth kiln or in a pusher kiln.

In one embodiment of the present invention, the mean particle diameter (D50) of electrode active materials made according to the inventive process is in the range of from 6 to 12 μm, preferably 7 to 10 μm.

The invention is further illustrated by working examples.

The residual Li₂CO₃ was determined by titration with 0.2 M HCl to a pH value of 4.5.

### I. Manufacture of Precursor (A.1)

A stirred tank reactor was filled with deionized water and 49 g of ammonium sulfate per kg of water. The solution was tempered to 55° C. and a pH value of 12 was adjusted by adding an aqueous sodium hydroxide solution.

The co-precipitation reaction was started by simultaneously feeding an aqueous transition metal sulfate solution and aqueous sodium hydroxide solution at a flow rate ratio of 1.8, and a total flow rate resulting in a residence time of 8 hours. The transition metal solution contained Ni, Co and Mn at a molar ratio of 6:2:2 and a total transition metal concentration of 1.65 mol/kg. The aqueous sodium hydroxide solution was a 25 wt. % sodium hydroxide solution and 25 wt. % ammonia solution in a weight ratio of 6. The pH value was kept at 12 by the separate feed of an aqueous sodium hydroxide solution. Beginning with the start-up of all feeds, mother liquor was removed continuously. After 33 hours all feed flows were stopped. The mixed transition metal (TM) oxyhydroxide precursor (A.1) was obtained by filtration of the resulting suspension, washing with distilled water, drying at 120° C. in air and sieving. The mean particle diameter (D50) was 12 μm.

### II. Inventive Process

II.a Mixing with Lithium Compound (B.1), Step (a.1)

10.19 kg Precursor (A.1) and 3.92 kg Li₂CO₃ (B.1) were mixed in a vibratory mixer. A mixture was obtained, the molar ratio Li to the sum of Ni and Co and Mn was 0.95:1.00. The mixture was filled into saggars with loadings of 2 kg.

### II.b Calcination, Step (b.1)

In a roller hearth kiln, saggars containing the mixture obtained in II.a were heated to 750° C. and kept for six hours in a forced flow of oxygen/air (60% by vol. O₂, 40% by vol. N₂). The underlithiated electrode material so obtained was cooled down to ambient temperature. The underlithiated electrode material so obtained had a residual Li₂CO₃ content of 0.86% by weight.

II.c Mixing with Lithium Compound (B.2), Step (c.1)

11 kg underlithiated electrode material from II.b and and 373 g LiOH (B.2) were mixed in a vibratory mixer. A mixture was obtained, the molar ratio Li to the sum of Ni and Co and Mn was 1.02:1.00. The mixture was filled into saggars with loadings of 4 kg.

### II.d Second Heat Treatment Step, Step (d.1)

In a box kiln, saggars containing the mixture obtained in II.c were heated to 885° C. and kept for 8 hours in a forced flow of oxygen/air (60% by vol. 02, 40% by vol. N₂). The electrode active material so obtained was cooled down to ambient temperature and its residual Li₂CO₃ content was 0.11% by weight.

### COMPARATIVE EXAMPLE 1

The above process was repeated but the 373 g of LiOH (B.2) from step (c.1) were already added in step c-(a.1), and steps (c.1) and (d.2) were omitted. After calcination, an electrode active material was obtained that had a residual Li₂CO₃ content was at least 1.5% by weight.

### COMPARATIVE EXAMPLE 2

When Comparative Example 1 is repeated but the 373 g of LiOH (B.2) are replaced by 575 g of Li₂CO₃, an electrode active material is obtained after calcination that has a higher residual Li₂CO₃ content than the inventive example II.d.

1: A process for making an electrode active material satisfying formula Li₁₊ₓTM₁₋ₓO₂, wherein TM is a combination of Mn, Co and Ni, optionally in combination with at least one more metal selected from Al, Ti, and W, wherein at least 50 mole-% of TM is Ni, and x is in a range of from 0 to 0.2, said process comprising:
(a) mixing (A) a mixed oxide or oxyhydroxide or hydroxide of TM, and (B) at least one lithium compound selected from the group consisting of lithium hydroxide, lithium oxide and lithium carbonate, so that a molar ratio of Li to TM is in a range of from 0.70 to 0.97, to obtain a mixture;
(b) subjecting the mixture obtained in (a) to heat treatment at a temperature in a range of from 300 to 900° C., to obtain a material;
(c) mixing the material with at least one lithium compound (B), so that a total molar ratio of Li to TM is in range of from 1.0 to 1.1, to obtain a mixture; and
(a) subjecting the mixture obtained in (c) to heat treatment at a temperature in a range of from 700 to 1000° C.

2: The process of claim 1, wherein TM is a combination of transition metals satisfying formula (I)
(NiₐCo_{b}Mn_{c})_{1-d}M_{d} (I)
wherein
a is in a range of from 0.5 to 0.95,
b is in a range of from 0.025 to 0.2,
c is in a range of from 0.025 to 0.3,
d is in a range of from 0 to 0.1,
M is Al, Ti or Zr or a combination thereof, and
a+b+c=1.

3: The process of claim 1, wherein TM is a combination of transition metals satisfying formula (I)
(NiₐCo_{b}Mn_{c})_{1-d}M_{d} (I)
wherein
a is in a range of from 0.6 to 0.9,
b is in a range of from 0.05 to 0.2,
c is in a range of from 0.05 to 0.2,
d is in a range of from 0 to 0.1,
M is Al, and
a+b+c=1.

4: The process of claim 1, wherein said mixing in (a) is performed in a dry state.

5: The process of claim 1, wherein (b) is performed in a rotary kiln.

6: The process of claim 1, wherein (d) is performed in a roller hearth kiln or in a pusher kiln.

7: The process of claim 1, wherein (A) is obtained by co-precipitation of a mixed hydroxide of nickel, cobalt and manganese, followed by drying under air and dehydration.

8: The process of claim 1, wherein x is in a range of from 0.01 to 0.05.

9: The process of claim 1, wherein the at least one lithium compound (B) in (a) is different from the at least one lithium compound (B) in (c).

10: The process of claim 1, wherein in (a) the molar ratio of Li to TM is in a range of from 0.90 to 0.95.

11: The process of claim 1, wherein at least one compound (C) is added during (c) or immediately after (c), wherein the at least one compound (C) is a compound of Al, Ti or Zr.
